(19) United States
(12) Patent Application Publication
(10) Pub. No.: US 2005/0171780 A1
(43) Pub. Date: Aug. 4, 2005

(54) Speech-related object model and interface in managed code system

(75) Inventors: Philipp H. Schmid, Mercer Island, WA (US); Robert L. Chambers, Sammamish, WA (US); David Jeremy Guy Wood, Seattle, WA (US); Bo-June Hsu, Redmond, WA (US); Oscar H. Newkerk III, Kirkland, WA (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/772,096

(22) Filed: Feb. 3, 2004

(51) Int. Cl. G10L 11/00

(52) U.S. Cl. 704/270.1

(57) ABSTRACT

The present invention provides an object model that exposes speech-related functionality to applications that target a managed code environment. In one embodiment, the object model and associated interfaces are implemented consistently with other non-speech related interfaces supported across a platform.

### BACKGROUND OF THE INVENTION

The present invention relates to speech technology. More specifically, the present invention provides an object model and interface in managed code (that uses the execution environment for memory management, object lifetime, etc.) such that applications that target the managed code environment can quickly and easily implement speech-related features.

Speech synthesis engines typically include a decoder which receives textual information and converts it to audio information that can be synthesized into speech on an audio device. Speech recognition engines typically include a decoder which receives audio information in the form of a speech signal and identifies a sequence of words from the speech signal.

The process of making speech recognition and speech synthesis more widely available has encountered a number of obstacles. For instance, the engines from different vendors behave differently under similar circumstances. Therefore, it has, in the past, been virtually impossible to change synthesis or recognition engines without inducing errors in applications that have been written with those engines in mind. Also, interactions between application programs and engines can be complex, including cross-process data marshalling, event notification, parameter validation, and default configuration, to name just a few of the complexities.

In an effort to make such technology more readily available, an interface between engines and applications was specified by a set of application programming interfaces (API) referred to as the speech application programming interface (SAPI). A description of a number of the features in SAPI are set out in U.S. Patent Publication Number US-2002-0069065-A1.

While these features addressed many of the difficulties associated with speech-related technology, and while they represent a great advancement in the art over prior systems, a number of difficulties still present themselves. For instance, the SAPI interfaces have not been developed and specified in a manner consistent with other interfaces in a wider platform environment, which includes non-speech technologies. This has, to some extent, required application developers who wish to utilize speech-related features offered by SAPI to not only understand the platform-wide API's and object models, but to also understand the speech-specific API's and object models exposed by SAPI.

### SUMMARY OF THE INVENTION

The present invention provides an object model that exposes speech-related functionality to applications that target a managed code environment. In one embodiment, the object model and associated interfaces are implemented consistently with other non-speech related object models and interfaces supported across a platform.

In one specific embodiment of the invention, a dynamic grammar component is provided such that dynamic grammars can be easily authored and implemented on the system. In another embodiment, dynamic grammar sharing is also facilitated. Further, in accordance with yet another embodiment, an asynchronous control pattern is implemented for various speech-related features. In addition, semantic properties are presented in a uniform fashion, regardless of how they are generated in a result set.

### BRIEF DESCRIPTION OF THE DRAWINGS

FIG. 1 is a block diagram of one illustrative environment in which the present invention can be used.

FIG. 2 is a block diagram illustrating a platform-wide environment in which the present invention can be used.

FIG. 3 is a more detailed block diagram illustrating components of a speech recognition managed code subsystem shown in FIG. 2.

FIG. 4 is a more detailed block diagram showing components of a text-to-speech (TTS) managed code subsystem shown in FIG. 2.

FIG. 5A is a flow diagram illustrating how the present invention can be used to implement speech recognition tasks.

FIG. 5B is a flow diagram illustrating how the present invention can be used to implement speech synthesis tasks.

FIG. 6 is a flow diagram illustrating how a grammar is generated in accordance with one embodiment of the present invention.

FIG. 7 illustrates an XML definition of a simplified grammar.

FIG. 8 illustrates the definition, and activation of a grammar in accordance with one embodiment of the present invention.

FIG. 9 is a block diagram illustrating dynamic sharing of grammars.

FIG. 10 is a flow diagram illustrating the operation of the system shown in FIG. 9.

Appendix A fully specifies one illustrative embodiment of a set of object models and interfaces used in accordance with one embodiment of the present invention.

### DETAILED DESCRIPTION OF THE PREFERRED EMBODIMENTS

The present invention deals with an object model and API set for speech-related features. However, prior to describing the present invention in greater detail, one illustrative embodiment of a computer, and computing environment, in which the present invention can be implemented will be discussed.

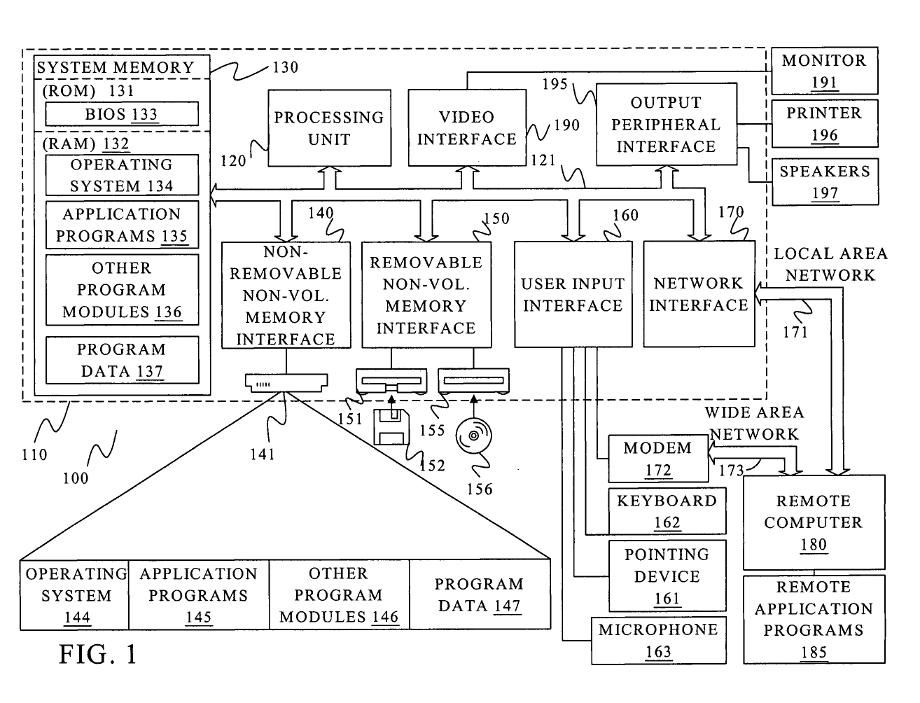

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer. 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

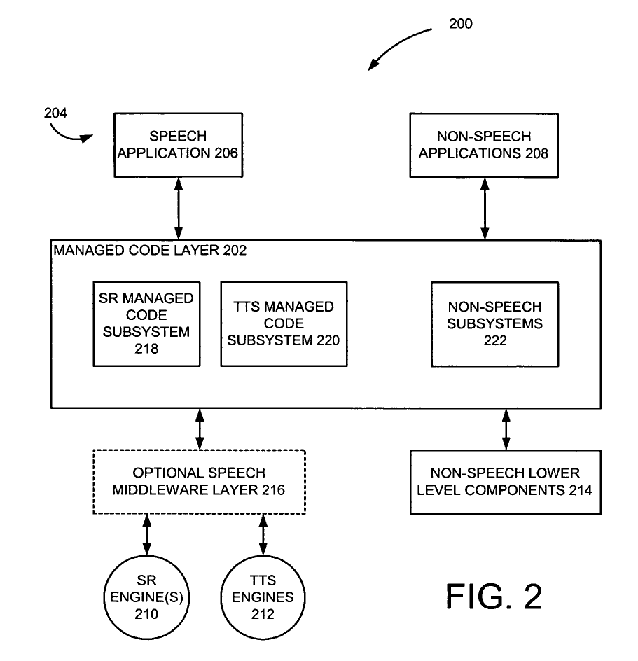

FIG. 2 is a block diagram of a platform-wide system 200 on which the present invention can be used. It can be seen that platform-wide environment 200 includes a managed code layer 202 that exposes members (such as methods, properties and events) to applications in an application layer 204. The applications illustrated in FIG. 2 include a speech-related application 206 and other non-speech related applications 208.

Managed code layer 202 also interacts with lower level components including speech recognition engine(s) 210 and text-to-speech (TTS) engine(s) 212. Other non-speech lower level components 214 are shown as well. In one embodiment, managed code layer 202 interacts with SR engines 210 and TTS engines 212 through an optional speech API layer 216 which is discussed in greater detail below. It should be noted, of course, that all of the functionalities set out in optional speech API layer 216, or any portion thereof, can be implemented in managed code layer 202 instead.

FIG. 2 shows that managed code layer 202 includes a number of subsystems. Those subsystems include, for instance, speech recognition (SR) managed code subsystem 218, TTS managed code subsystem 220 and non-speech subsystems 222.

Thus, the managed code layer 202 exposes programming object models and associated members that allow speech-related application 206 to quickly, efficiently and easily implement speech-related features (such as, for example, speech recognition and TTS features) provided by SR engine(s) 210 and TTS engine(s) 212. However, because managed code layer 202 is developed consistently across the entire platform 200, the programming models and associated members exposed by layer 202 in order to implement speech-related features are consistently with (designed consistently using the same design principles as) the programming models and members exposed by managed code layer 202 to non-speech applications 208 to implement non-speech related features.

This provides significant advantages over prior systems. For instance, similar operations are treated similarly across the entire platform. Asynchronous loading a picture into a PictureBox object, for example, is treated similarly (at the level of the programming models and members exposed by managed code layer 202) to an asynchronous speech synthesis operation. Similarly, objects and associated member are specified and accessed in the same way across the entire platform. Thus, a user need not learn two different systems when implementing speech-related features and non-speech related features. This significantly enhances the likelihood that speech-related technologies will gain wider acceptance.

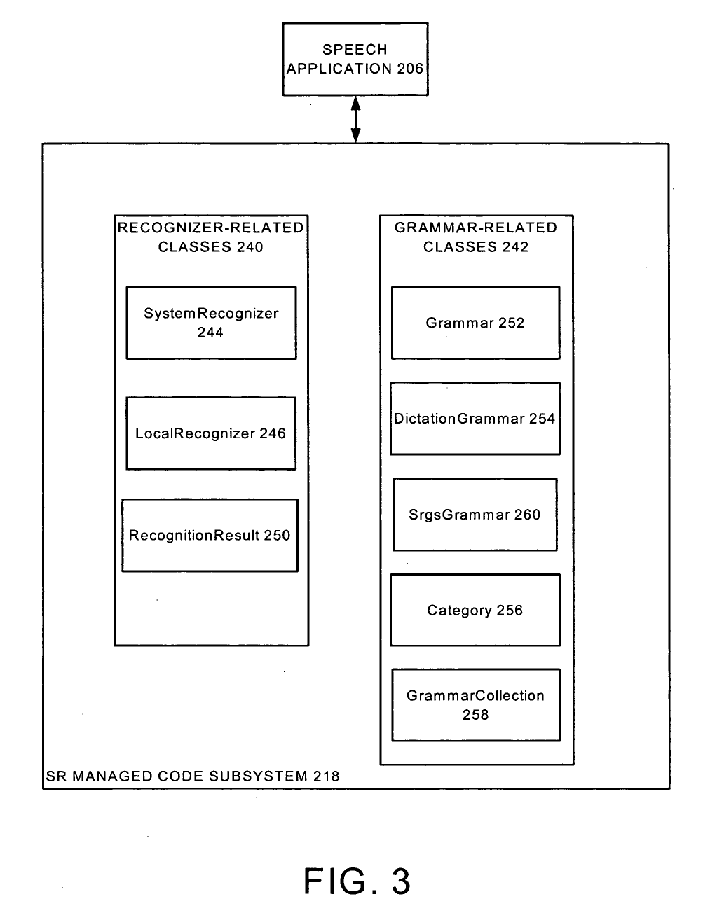

FIG. 3 is a more detailed block diagram of SR managed code subsystem 218 shown in FIG. 2. It will, of course, be noted that a wide variety of other or different components can be used in SR managed code subsystem 218, other than those shown. For instance, Appendix A contains one illustrative embodiment of a set of components that can be implemented in subsystem 218, and only a small subset of those are shown in FIG. 3, for the purpose of clarity. In addition, it will be appreciated that Appendix A sets out but one illustrative embodiment of components used in subsystem 218. Those are specifically set out for use in a platform developed using the WinFX API set developed by Microsoft Corporation of Redmond, Wash. Therefore, the object models and associated member and APIs set out in Appendix A are developed consistently with the remainder of the WinFX API set. However, it will be appreciated that this is but one illustrative platform and the APIs object models and associated members implemented in any specific implementation will depend on the particular platform with which the speech-related API set and object models and associated members are used.

In any case, FIG. 3 shows that managed code subsystem 218 illustratively includes a set of recognizer-related classes 240 and a set of grammar-related classes 242. The recognizer-related classes shown in FIG. 3 include SystemRecognizer 244, LocalRecognizer 246, and RecognitionResult 250. Grammar-related classes 242 include Grammar 252, DictationGrammar 254, Category 256, GrammarCollection 258, and SrgsGrammar 260.

SystemRecognizer 244, in one illustrative embodiment, is an object class that represents a proxy to a system-wide speech recognizer instance (or speech recognition engine instance). SystemRecognizer 244 illustratively derives from a base class such as (Recognizer) from which other recognizers (such as LocalRecognizer 246) derive. SystemRecognizer 244 generates events for recognitions, partial recognitions, and unrecognized speech. SystemRecognizer 244 also illustratively exposes methods and properties for (among many other things) obtaining attributes of the underlying recognizer or recognition engine represented by SystemRecognizer 244, for returning audio content along with recognition results, and for returning a collection of grammars that are currently attached to SystemRecognizer 244.

LocalRecognizer 246 inherits from the base class recognizer 244 and illustratively includes an object class that represents an in-process instance of a speech recognition engine in the address space of the application. Therefore, unlike SystemRecognizer 244, which is shared with other processes in environment 200, LocalRecognizer 246 is totally under the control of the process that creates it.

Each instance of LocalRecognizer 246 represents a single recognition engine 210. The application 206 that owns the instance of LocalRecognizer 246 can connect to each recognition engine 210, in one or more recognition contexts, from which the application can control the recognition grammars to be used, start and stop recognition, and receive events and recognition results. In one embodiment, the handling of multiple recognition processes and contexts is discussed in greater detail in U.S. Patent Publication Number US-2002-0069065-A1.

LocalRecognizer 246 also illustratively includes methods that can be used to call for synchronous or asynchronous recognition (discussed in greater detail below), and to set the input source for the audio to be recognized. For instance, the input source can be set to a URI string that specifies the location of input data, a stream, etc.

RecognitionResult 250 is illustratively an object class that provides data for the recognition event, the rejected recognition event and hypothesis events. It also illustratively has properties that allow the application to obtain the results of a recognition. RecognitionResult component 250 is also illustratively an object class that represents the result provided by a speech recognizer, when the speech recognizer processes audio and attempts to recognize speech. RecognitionResult 250 illustratively includes methods and properties that allow an application to obtain alternate phrases which may have been recognized, a confidence measure associated with each recognition result, an identification of the grammar that produced the result and the specific rule that produced the result, and additional SR engine-specific data.

Further, RecognitionResult 250 illustratively includes a method that allows an application to obtain semantic properties. In other words, semantic properties can be associated with items in rules in a given grammar. This can be done by specifying the semantic property with a name/value pair or by attaching script to a rule that dynamically determines which semantic property to emit based on evaluation of the expression in the script. When a rule that is associated with a semantic property is activated during recognition (i.e., when that rule spawns the recognition result), a method on RecognitionResult 250 allows the application to retrieve the semantic property tag that identifies the semantic property that was associated with the activated rule. The handler object that handles the RecognitionEvent can then be used to retrieve the semantic property which can be used by the application in order to shortcut otherwise necessary processing. In accordance with one embodiment, the semantic property is retrieved and presented by RecognitionResult 250 as a standard collection of properties regardless of whether it is generated by a name/value pair or by script.

Grammar 252 is illustratively a base object class that comprises a logical housing for individual recognition rules and dictation grammars. Grammar 252 thus generates events when the grammar spawns a full recognition, a non-recognition, or a partial recognition. Grammar 252 also illustratively exposes methods and properties that can be used to load a grammar into the object from various sources, such as a stream or another specified location. The methods and properties exposed by Grammar object 252 also illustratively specify whether the grammar and individual rules in the grammar are active or inactive, and the specific speech recognizer 244 that hosts the grammar.

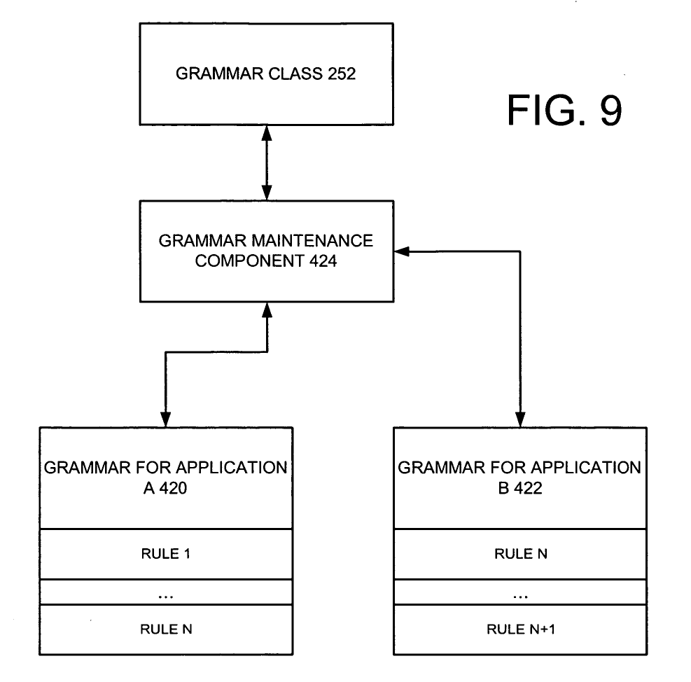

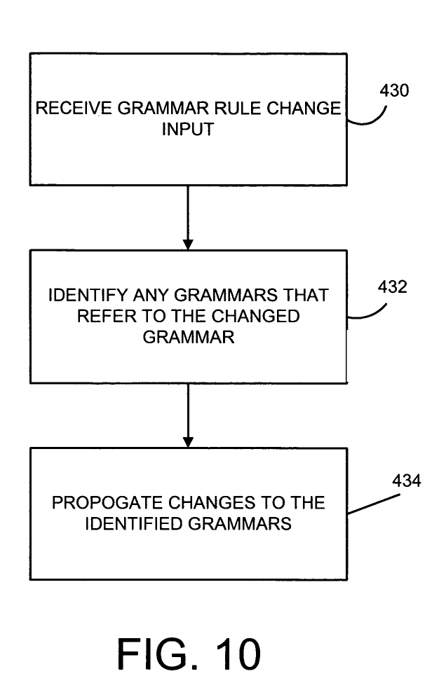

In addition, Grammar object 252 illustratively includes a property that points to another object class that is used to resolve rule references. For instance, as is discussed in greater detail below with respect to FIGS. 9 and 10, a rule within a grammar can, instead of specifying a rule, refer to a rule within another grammar. In fact, in accordance with one embodiment of the invention, a rule associated with one application can even refer to rules in grammars associated with separate applications. Therefore, in accordance with one embodiment, Grammar object 252 includes a property that specifies another object that is used to resolve rule references to rules in other grammars.

DictationGrammar 254 is illustratively an object class that derives from Grammar object 252. DictationGrammar object 254 includes individual grammar rules and dictation grammars. It also illustratively includes a Load method that allows these grammars to be loaded from different sources.

SrgsGrammar component 260 also illustratively inherits from the base Grammar class 252. However, SrgsGrammar class 260 is configured to expose methods and properties, and to generate events, to enable a developer to quickly and easily generate grammars that conform to the standardized Speech Recognition Grammar Specification adopted by W3C (the world wide web consortium). As is well known, the SRGS standard is an XML format and structure for defining speech recognition grammars. It includes a small number of XML elements, such as a grammar element, a rule element, an item element, and an one-of element, among others. The SrgsGrammar class 260 includes properties to get and set all rules and to get and set a root rule in the grammar. Class 260 also includes methods to load SrgsGrammar class instances from a string, a stream, etc.

SrgsGrammar 260 (or another class) also illustratively exposes methods and properties that allow the quick and efficient dynamic creation and implementation of grammars. This is described in greater detail with respect to FIGS. 6-8 below.

Category 256 is described in greater detail later in the specification. Briefly, Category 256 can be used to associate grammars with categories. This better facilitates use of the present invention in a multi-application environment.

GrammarCollection component 258 is illustratively an object class that represents a collection of grammar objects 252. It illustratively includes methods and properties that allow an application to insert or remove grammars from the collection.

While FIG. 3 illustrates a number of the salient object classes found in SR managed code subsystem 218 and while a number of the methods, events, and properties exposed by those object classes have been discussed herein, one embodiment of a set of those object classes and their exposed members is set out in Appendix A hereto. In addition other or different classes could be provided as well and functionality can be combined into a smaller set of classes or divided among more helper classes in accordance with various embodiments of the invention.

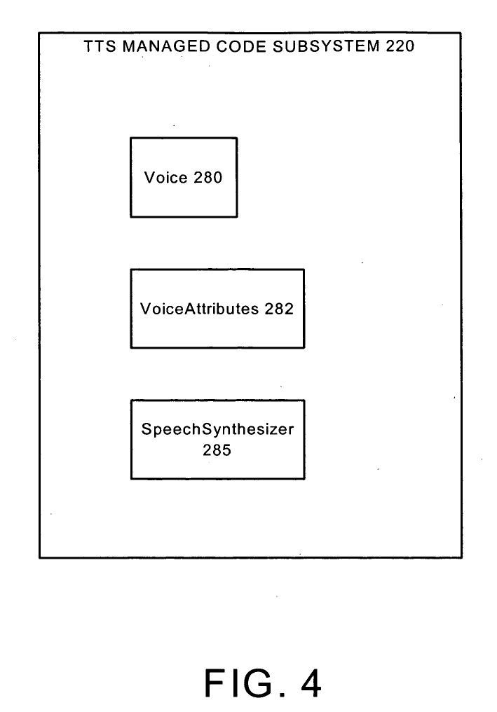

FIG. 4 illustrates a more detailed block diagram of a portion of TTS managed code subsystem 220 in accordance with one embodiment of the present invention. FIG. 4 illustrates that subsystem 220 includes Voice 280, VoiceAttributes 282, and SpeechSynthesizer 285. Synthesis-related components 280-285 expose methods, events and properties that allow an application to take advantage of speech synthesis features in a quick and efficient manner.

Voice 280 is illustratively a primary object class that can be accessed in order to implement fundamental speech synthesis features. For instance, in one illustrative embodiment, Voice class 280 generates events when speech has started or ended, or when bookmarks are reached. It also illustratively includes methods which can be called to implement a speak operation, or an asynchronous speak operation. Those methods also allow the application to specify the source of the input to be spoken. Similarly, Voice class 280 illustratively exposes properties and methods which allow an application to get the attributes of the voice, get and set the rate of speech and the particular synthesizer where this Voice class 280 is to be used, as well as to get and set the volume of the voice.

VoiceAttributes 282 is illustratively an object class that represents the attributes of the TTS voice being used to synthesize the input. VoiceAttributes class 282 illustratively exposes a method that allows an application instantiate a voice by interacting through a list of available voices and checking properties of each voice against desired properties or by specifying another identifier for the voice. Such properties can include, for example, the approximate age of the speaker, the desired gender for the speaker, a platform-specific voice, cultural information related to the speaker, audio formats supported by the synthesizer to be used, or a specific vendor that has provided the voice.

SpeechSynthesizer 285 is illustratively an object class that exposes elements used to represent a TTS engine. SpeechSynthesizer 285 exposes methods that allow pause, skip and resume operations. It also generates events for changes in audio level, and synthesis of phonemes and visemes. Of course, other exposed members are discussed in Appendix A hereto.

Again, as with respect to FIG. 3, FIG. 4 shows but a small number of the actual object classes that can be used to implement TTS managed code subsystem 220. In addition, a small number of methods, events, and properties exposed by those object classes is discussed herein. However, one embodiment of a set of object classes and the events, properties and methods exposed by those object classes is set out in Appendix A hereto. Also, fewer classes can be used or additional helper classes can be used.

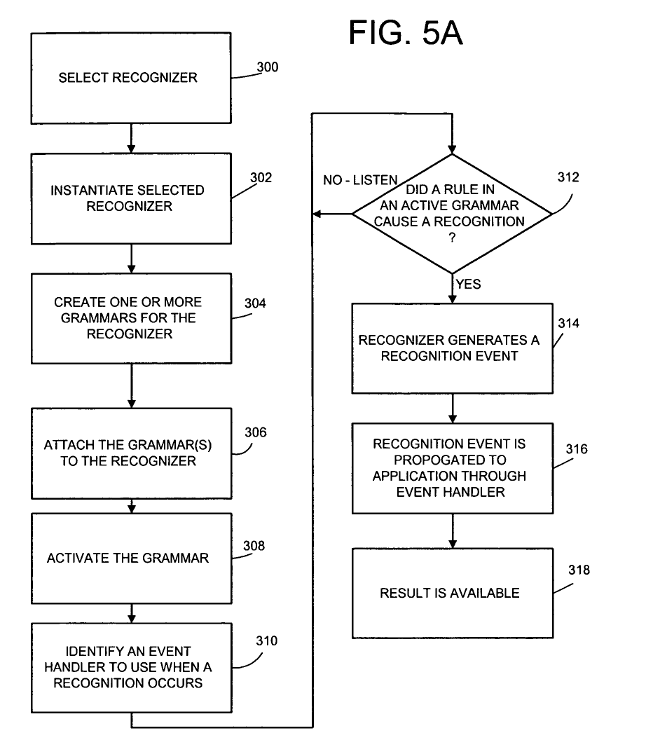

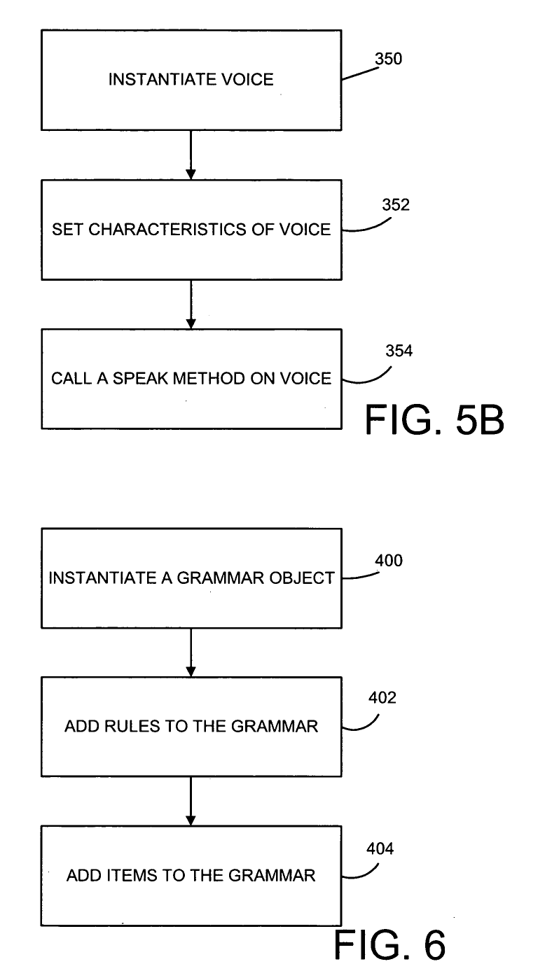

FIG. 5A is a flow diagram illustrating how an application 206 might take advantage of the speech recognition features exposed by managed code layer 202 shown in FIG. 2. Of course, a small number of features are illustrated in the flow diagram of FIG. 5A, and they are shown for illustrative purposes only. They are not intended to limit the scope or applicability of the present invention in any way.

In any case, a recognizer, (such as SystemRecognizer 244 or LocalRecognizer 246) is first selected and the selected recognizer is instantiated. This is indicated by blocks 300 and 302 in FIG. 5A. Next, one or more grammars (such as grammar classes 252, 254, 256 or 260) are created for the recognizer instantiated in block 302. Creation of the grammar for the recognizer is indicated by block 304. Creation of a grammar is discussed in greater detail with respect to FIGS. 6-8.

Once the grammar is created, it is attached to the recognizer. This is indicated by block 306 in FIG. 5A. The grammar, once attached to the recognizer, is then activated. This is indicated by block 308.

After the grammar has been activated, an event handler that is to be used when a recognition occurs is identified. This is indicated by block 310. At this point, the speech recognizer has been instantiated and a grammar has been created and assigned to it. The grammar has been activated and therefore the speech recognizer is simply listening and waiting to generate a recognition result from an input.

Thus, the next step is to wait until a rule in an active grammar has caused a recognition. This is indicated by block 312. When that occurs, the recognizer generates a recognition event at block 314. The recognition event is propagated to the application through the event handler. This is indicated at block 316. A RecognitionResult class is also generated and made available to the application. This is indicated by block 318. The application, having access to the RecognitionEventArgs and RecognitionResult classes can obtain all of the necessary information about the recognition result in order to perform its processing. Of course, since the recognition event and the recognition result are propagated up to the application layer through managed code layer 202, they are provided to the application layer through APIs and an object model and associated members that are consistent with the APIs and object model and associated members used to provide other non-speech applications with information, across the platform.

FIG. 5B is a flow diagram illustrating how an application 206 can utilize TTS features exposed by the present invention. In the embodiment illustrated in FIG. 5B, the application first instantiates a Voice class (such as Voice class 280). This is indicated by block 350, of course, the Voice class instantiated can be selected by default or it can be selected by attributes of the speaker, an identifier for a particular Voice class, the vendor that provides a given synthesizer, etc.

Next, the application can set the characteristics of the voice to be synthesized. This is indicated by block 352. Again, of course, the application need not revise or set any characteristics of the voice, but can simply provide a source of information to be synthesized and call the Speak method on Voice class 280. Default voice characteristics will be used. However, as illustrated in FIG. 5B, the application can, if desired, manipulate the characteristics of the voice to be synthesized, by manipulating a wide variety of voice characteristics.

Next, the application calls a Speak method on Voice class 280. This is indicated by block 354. In one illustrative embodiment, the application can call a synchronous speak method or an asynchronous speak method. If the synchronous speak method is called, the instantiated TTS engine generates the synthesis data from the identified source and the method returns when the TTS engine has completed that task.

However, the application can also call an asynchronous speak method on Voice class 280. In that case, a Voice class 280 can return to the application a pointer to another object that can be used by the application to monitor the progress of the speech synthesis operation being performed, to simply wait until the speech synthesis operation is completed, or to cancel the speech synthesis operation, of course, it should be noted that in another embodiment the Voice class itself implements these features rather than pointing the application to a separate object. In any case, however, the asynchronous speech pattern is illustratively enabled by the present invention. When the speech operation is complete an event is generated.

Again, as with the flow diagram set out in FIG. 5A, since the speech synthesis features are invoked through managed code layer 202, they are invoked through an API and object model and associated members that are consistent with other APIs and object models across the entire platform, even for those directed to non-speech technologies.

FIGS. 6-8 illustrate one embodiment used in the present invention to build and manage dynamic grammars. Because, as mentioned above, SRGS has emerged as a standard way of describing grammars, SrgsGrammar class 260 is provided for building and managing dynamic grammars that support the XML format established by SRGS. However, DynamicGrammar class 250 could be used to build and manage other grammars as well. However, for the sake of clarity, the present example will proceed with respect to SrgsGrammar class 260 only.

FIG. 6 is a simplified flow diagram illustrating how a DynamicGrammar can be built. First, a grammar object is instantiated (such as SrgsGrammar class 260). This is indicated by block 400 in FIG. 6. Once the grammar class is instantiated, rules are added to the grammar, and items are added to the rules in the grammar. This is indicated by blocks 402 and 404 in FIG. 6.

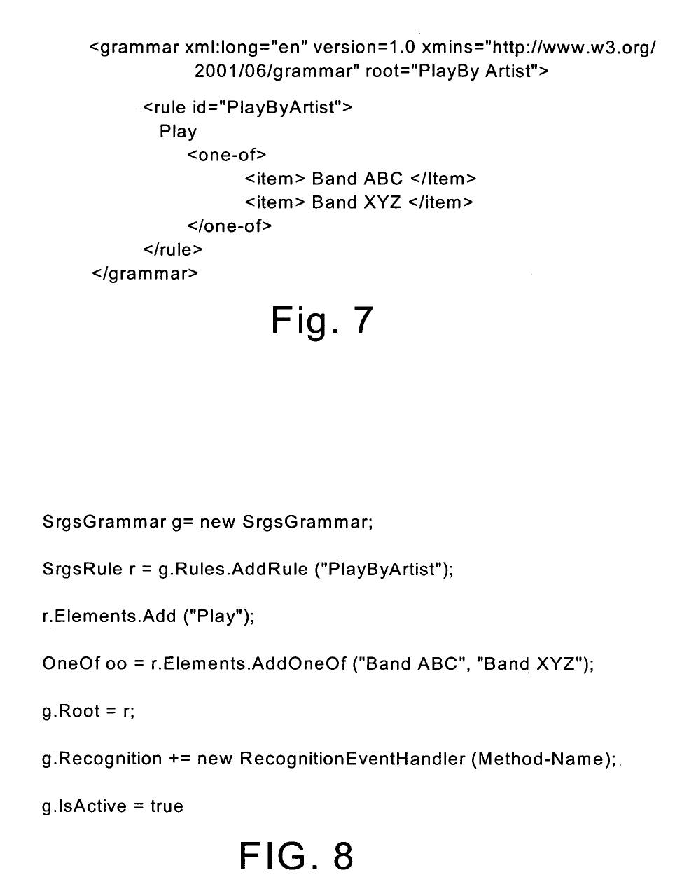

FIG.7 illustrates one implementation, using XML, to define a simplified grammar. The specific recognizer can then compile this into its internal data structures. The XML statements set out in FIG. 7 begin by instantiating a grammar and then generating a rule for the grammar. The rules in the exemplary grammar shown in FIG. 7 will be used to identify commands to a media component to play music based on the name of the artist. Therefore, the exemplary grammar in FIG. 7 will be configured to recognize commands such as “Play Band ABC” where “Band ABC” is the name of an artist or band. Thus, FIG. 7 shows a rule ID that identifies the name of the rule being created. The rule is named “PlayByArtist”. The rule contains a number of elements. The first element is “Play” and it contains an “one-of” element. The “one-of” element is a list of all of the different artists for which the media component has stored music.

It will be noted, in accordance with the present invention, instead of specifying the “one-of” element the rule could contain a reference to another rule which specifies the list of artists.

Such a statement could be:
<ruleref uri=“#ArtistNames”>.

In that statement, the URI identifies a uniform resource identifier for the artist names. The rule for the artist names can be written to take artist names from a database, by performing a database query operation, by identifying an otherwise already compiled list of artist names, or by specifying any other way of identifying artist names. However, in one embodiment, the artist names rule is left empty and is computed and loaded at run time. Therefore, the list of artists need not already be generated and stored in memory (and thus consuming memory space). Instead, it can be generated at run time and loaded into the grammar, only when the grammar is instantiated.

FIG. 8 illustrates another method of building a grammar in accordance with the present invention, that greatly simplifies the task, over that shown with respect to FIG. 7. The first line in FIG. 8 creates a grammar g by instantiating the SrgsGrammar class 260.

The second line in FIG. 8 adds a rule to the SrgsGrammar class 280 already instantiated. In the statement the rule, r, is added by referring to the already created grammar g, and a rules collection in grammar g, and then by calling the AddRule method that enables naming of the rule being added. Therefore, the second line in FIG. 8 generates a rule with the name “PlayByArtist”.

Once the grammar object g has been created, and a rule object r has been created, the next task is to identify an item to be included in the rule. Thus, the third line of FIG. 8 identifies the rule r, accesses the elements of the rule (wherein elements is a generic container of everything in the rule) and calls the AddItem method which names the item to be added “play.”

The next step is to create an item object containing a list of all of the artists for which music has been stored. Therefore, the fourth line includes a OneOf statement that identifies the rule r, the elements container, and calls the AddOneOf method that contains a list of all of the artists. The rule r is then identified as the root. FIG. 8 shows that lines 1-5 of the C# code illustrated therein have accomplished the same thing as the nine lines of XML shown in FIG. 7. They have also accomplished this in a way that is highly intuitive to those that are familiar with the SRGS standard.

The last three lines of FIG. 8 simply make the grammar g active, and identify an event handler used to handle recognition events generated from the grammar. The “MethodName” in the last line of FIG. 8 is simply a method which is written to receive the event.

The grammar can be made even more dynamic by replacing the fourth line of code shown in FIG. 8. Instead of listing out all of the artists in the line of code, assume that a dynamic array of artists is defined by a separate expression, and it is that dynamic array of artists which is calculated at run time and which is to be used to identify the artist in the grammar. In that case, instead of listing the artists in line four of FIG. 8, an empty “OneOf” object is created as follows:
OneOf oo=r.elements.AddoneOf( )

The empty OneOf object is filled at run time. Using standard platform-based conventions and constructs, the empty OneOf object can be filled in as follows:

foreach (string artist in [xyz])
{
OneOf oo.Elements.AddItem(artist);
}

where the [xyz] is an expression that will be evaluated at run time to obtain a set of artists in an array. This expression can be a relational database query, a web service expression, or any other way of specifying an array of artists.

FIGS. 9 and 10 illustrate the process of dynamic grammar sharing. As discussed above, a rule within a grammar can be configured to refer to a rule within another grammar. For instance, FIG. 9 shows that grammar 420 has been created and associated with an Application A. FIG. 9 also shows that grammar 422 has been created and associated with an Application B. FIG. 9 illustrates that rule one in grammar 420 actually contains a reference to rule n in grammar 422. However, this can present problems with dynamic grammars. For instance, dynamic grammars routinely change because they are often computed at run time, each time the grammar is instantiated. Therefore, unless some mechanism is provided for maintaining consistencies between shared grammars, problems can result with respect to grammars becoming out of date relative to one another.

The present invention thus provides a grammar maintenance component 424 that is used to maintain grammars 420 and 422. Hence, when a grammar class, such as Grammar class 252, is invoked to add or change a rule, that is detected by grammar maintenance component 424. For instance, assume that an application invokes a method on Grammar class 252 to change a rule in grammar 420 for Application A. Grammar maintenance component 424 detects a change in that rule and identifies all of the grammars that refer to that rule so that they can be updated with the changed rule. In this way, even dynamic grammars can be shared and can refer to one another without the grammars becoming outdated relative to one another.

FIG. 10 is a simplified flow diagram illustrating this in greater detail. First, grammar maintenance component 424 receives a grammar rule change input indicating that a rule is going to be changed. This is indicated by block 430 in FIG. 10.

Next, component 424 identifies any grammars that refer to the changed grammar. This is indicated by block 432. Component 424 then propagates changes to the identified grammars as indicated by block 434.

In one embodiment, grammar maintenance component 424 is implemented in the optional speech API layer 216 (such as SAPI). However, it could be fully implemented in managed code layer 202 as well.

While a plurality of other features are further defined in Appendix A hereto, an additional feature is worth specifically mentioning in the specification. The present invention can illustratively be used to great benefit in multiple-application environments, such as on the desktop. In such an environment, multiple applications are often running at the same time. In fact, those multiple applications may all be interacting with managed code layer 202 to obtain speech-related features and services.

For instance, a command-and-control application may be running which will recognize and execute command and control operations based on a spoken input. Similarly, however, a dictation application may also be running which allows the user to dictate text into a document. In such an environment, both applications will be listening for speech, and attempting to activate grammar rules to identify that speech.

It may happen that grammar rules coincide in different applications such that grammars associated with two different applications can be activated based on a single speech input. For instance, assume that the user is dictating text into a document which includes the phrase “The band wanted to play music by band xyz.” Where the phrase “band xyz” identifies an artist or band. In that instance, the command and control application may activate a rule and attempt to invoke a media component in order to “play music by band xyz.” Similarly, the dictation application may attempt to identify the sentence dictated using its dictation grammar and input that text into the document being dictated.

In accordance with one embodiment of the present invention, and as discussed above, with respect to FIG. 3, each grammar is thus associated (such as through the Category class 256) with a category that may, or may not, require a prefix to be stated prior to activating a rule. For instance, if the command and control application is minimized (or not under focus) its grammar may require a prefix to be spoken prior to any rule being activated. One example of this includes attaching a prefix to each rule wherein the prefix identifies a media component used to synthesize speech. The prefix to the rule thus requires the user to name the media component before giving a command and control statement to be recognized. For instance, when the command and control application is minimized, it may configure the rules such that they will not be activated simply by the user stating. “Play music by band xyz.” Instead, they will only be activated if the user states “Media component play music by band xyz.” The grammar classes illustratively do this by including a property referred to as the “PrefixAlways Required” property. If that property is set to true, then the value of the prefix must be included in the statement before the rule in that grammar will be activated. If it is set to false, then the prefix need not be stated for the rule to be activated.

The property value will be changed based on different contexts. This allows the present system to be used in a multi-application environment while significantly reducing the likelihood that misrecognitions will take place in this way.

It can thus be seen that the present invention provides an entirely new API and object model and associated members for allowing speech-related features to be implemented quickly and easily. The API and object model have a form that is illustratively consistent with other APIs and object models supported by a platform-wide environment. Similarly, the present invention can be implemented in a managed code environment to enable managed code applications to take advantage of speech-related features very quickly and easily.

The present invention also provides a beneficial mechanism for generating and maintaining dynamic grammars, for eventing, and for implementing asynchronous control patterns for both speech synthesis and speech recognition features. One embodiment of the present invention sits on top of a API layer, such as SAPI, and wraps and extends the functionality provided by the SAPI layer. Thus, that embodiment of the present invention can utilize, among other things, the multi-process shared engine

1. A computer readable medium having stored thereon computer readable instructions, comprising:
a managed code layer having a speech-related object model comprising objects exposing speech-related members for use by speech-related applications in performing speech processing tasks.

2. The computer readable medium of claim 1 wherein the managed code layer is configured to include a non-speech related object model comprising objects exposing non-speech related members for use by applications to perform non-speech related processing tasks.

3. The computer readable medium of claim 2 wherein the speech-related object model and non-speech related object model are accessed using accessing techniques that are the same for both object models.

4. The computer readable medium of claim 3 wherein the non-speech related members exposed by a non-speech related object in the non-speech related object model include methods, properties acted on by the methods, and events triggered by a state of the non-speech related object.

5. The computer readable medium of claim 4 wherein the speech-related members exposed by a speech-related object in the speech-related object model include methods, properties acted on by the methods, and events triggered by a state of the speech-related object.

6. The computer readable medium of claim 5 wherein the speech-related members and non-speech related members all designed to be specified and invoked in a consistent way.

7. The computer readable medium of claim 1 wherein the speech-related object model includes:
a recognizer object configured to represent a speech recognizer.

8. The computer readable medium of claim 7 wherein the speech-related object model includes:
a grammar object model configured to represent a grammar used by the recognizer object in recognizing speech.

9. The computer readable medium of claim 8 wherein the speech-related object model includes a result object configured to represent a recognition result.

10. The computer readable medium of claim 9 wherein the speech-related object model includes an event handler object configured to handle events generated by the recognizer object.

11. The computer readable medium of claim 7 wherein the recognizer object comprises a local recognizer object controlled by a process that instantiated the local recognizer object.

12. The computer readable medium of claim 11 wherein the recognizer object comprises a system recognizer object shared by multiple processes.

13. The computer readable medium of claim 8 wherein the grammar object comprises a XML-based grammar object having exposed members accessible to create a grammar using XML expressions.

14. The computer readable medium of claim 8 wherein the grammar object comprises a dictation grammar object representing a dictation grammar.

15. The computer readable medium of claim 8 wherein the grammar object comprises a dynamic grammar object having exposed members accessible to create a dynamic grammar that is dynamically generated at runtime.

16. The computer readable medium of claim 8 wherein the grammar represented by the grammar object has semantic properties associated with rules therein.

17. The computer readable medium of claim 16 wherein the semantic properties are emitted based on one of a plurality of different mechanisms.

18. The computer readable medium of claim 17 wherein the speech-related object model exposes members to provide the semantic properties in a consistent form regardless of the mechanism used to emit the semantic properties.

19. The computer readable medium of claim 1 wherein the speech-related object model comprises a voice object configured to represent a speech synthesizer.

20. The computer readable medium of claim 19 wherein the voice object exposes members accessible to call a synchronous speak operation and a non-synchronous speak operation.

21. The computer readable medium of claim 19 wherein the speech-related object model includes exposed members accessible to specify a synthesizer based on voice characteristics.

22. The computer readable medium of claim 19 wherein the speech-related object model includes a voice attributes object representing attributes of a synthesized voice.

23. The computer readable medium of claim 19 wherein the speech-related object model includes a synthesis event handler configured to handle events generated by the voice object.

24. The computer readable medium of claim 1 wherein the speech-related object model includes a first grammar object representing a first grammar and a second grammar object representing a second grammar and wherein the first grammar has a rule that refers to a rule in the second grammar.

25. The computer readable medium of claim 24 wherein the speech related object model includes a grammar maintenance component that updates the first grammar when the referred to rule in the second grammar changes.

26. An object model, comprising:
a set of speech-related objects exposing members, accessible by applications that target managed code to perform speech-related tasks.

27. The object model of claim 26 wherein the exposed members are accessible to perform speech recognition tasks.

28. The object model of claim 26 wherein the exposed members are accessible to perform speech synthesis tasks.

29. The object model of claim 26 wherein the exposed members are accessible using techniques that are the same as techniques used to access members exposed by non-speech related objects in a platform that contains the speech-related objects.

30. The object model of claim 26 wherein the speech-related objects include a dynamic grammar object that exposes members accessible to implement a dynamic grammar.
